(19) United States
(12) Patent Application Publication
(10) Pub. No.: US 2008/0280785 A1
(43) Pub. Date: Nov. 13, 2008

(54) FLUIDIC NANO/MICRO ARRAY CHIP AND CHIPSET THEREOF

(75) Inventors: Fan Gang Tseng, Hsinchu City (TW); Cheng En Ho, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/110,551

(22) Filed: Apr. 28, 2008

(30) Foreign Application Priority Data
May 9, 2007 (TW) 096116367

(51) Int. Cl. C40B 60/14

(52) U.S. Cl. 506/40

(57) ABSTRACT

A fluidic nano/micro array chipset comprises a microarray filling chip and a nano/micro array stamping chip. There are a plurality of sample containers and a plurality of nano/micro channels on the top of the microarray filling chip, and a plurality of nano/micro-scaled micro filling holes on the bottom of the microarray filling chip. Each nano/micro channel is connected to one of the sample containers and leads the sample solution in that sample container to the corresponding micro filling hole. The nano/micro array stamp chip comprises a plurality of stamping heads arranged in an array pattern, with a body part of the stamp chip and a plurality of space channels forming hydrophobic areas. Each sample solution is stored in the body of the stamp chip, and is transported by the corresponding stamping head to the stamping part of this stamping head.

### BACKGROUND OF THE INVENTION

(A) Field of the Invention

The present invention relates to a fluidic nano/micro array chip and the chipset thereof, and more particularly, to a microarray chip applicable to pharmaceutical research, biomedical research and a diagnostic system including biological samples.

(B) Description of the Related Art

Protein chips fabricated by microarray techniques can effectively reduce the protein targeting process time and help researchers understand the proteins' behavior and the interaction between molecules by inspecting tens to hundreds of samples simultaneously in one experiment. This type of protein chip not only helps sorting medications, but also helps finding the targets of specific diseases and cancer tumors, so such protein chips can be used in disease detection and biological protein research. Generally, only a few samples are necessary to quickly and precisely detect a specific disease or cancer and to measure the effects of various drugs on a targeted protein. So this technique has become an important tool in biomedical research. Currently, there are several protein microarray fabricating methods such as a robotic micro-pipetting method, a photolithographic method, an inkjet nozzle method, a micro press embossing method and a dip pen lithographic method utilizing an atomic microscope.

The publication of Stanford University researcher Pat Brown's technique of fabricating the microarray biochip by a fine control movable platform has made a great impact on the fields of genetic research tools and even clinical medical diagnostics. However, the disadvantages of this biochip fabricating platform are that its throughput is too slow (micro-printing systems produce 100 chips per day), its cost is too high (at three to five hundred dollars per chip), its reaction time is more than 8 hours, and it requires a specialist to operate the machine and analyze the results. Furthermore, other disadvantages exist: the multi-pipette robotic arm or inkjet nozzle used in the platform limits its operation speed; it requires a precisely controllable and moveable platform; and pinpoints and pipes must be cleansed when the reagent is to be replaced in order to prevent contamination of samples.

The process of the photolithographic technique with self-assembled monolayer (SAM) immobilizing proteins includes the steps of spinning photoresist, development, defining the attached locations of the proteins by dispensing them on an SAM material, and forming the proteins in a manner of a micro-array in the predetermined locations after the protein samples react with the biochip. This protein bonding method, which needs to fix tens of types of samples simultaneously, is very tedious and thus is very hard to be implemented. In addition, the remaining organic solvent affects the activity of the proteins.

The micro-jetting method first drops the protein samples in the protein reservoir by a dropper or a robotic arm, and the micro flow channel system on the chip directs the samples to the nozzle hole in the center of the protein reservoir by surface tension. The actuator made by piezoelectric materials on the top of the nozzle hole squeezes the samples in the nozzle hole to form a liquid-droplet array, and the liquid-droplet array is then stamped and immobilized on the chip. However, the shapes of the liquid droplets may be irregular due to the high injection speed that occurs. If one actuator controls one nozzle hole, then the number of the samples on each chip is quite limited. Furthermore, its pipes and nozzle holes must be cleansed to prevent contamination of the samples.

The electrical spraying method needs a voltage of 3 to 4 kV to spray protein solution from the positive side to the negative base material. This way, however, not only is too much sample solution wasted due to the mask, but also the influence of the high voltage to the biological samples has to be taken into consideration. The dip pen lithographic method can produce a nano-scaled protein array, but each point of the array takes 30 seconds for dipping. Other than the time inefficiency issue, there is also a need for a doctor or a biochemical professional to personally inspect results by using a platform conducive to analysis such that a commercialized protein micro-array fabricated by the dip pen lithographic method can be obtained. In fact, this method is not yet available for practical commercial application.

Whiteside provides a technique using the molding method that molds and releases an elastic high polymer material, such as polydimethylsiloxane (PDMS), to form a micro stamp, which several substances, such as protein solution, genetic solution and SAM, can uniformly contact with a base material, and then these substances are printed on a surface of the micro stamp. The advantages of these stamp chips are that their fabrication cost is low, they are disposable, and they can print hundreds of dots simultaneously and in parallel. However, these PDMS micro stamps cannot print tens of different kinds of samples on the biological reaction chip simultaneously while maintaining a small size.

### SUMMARY OF THE INVENTION

One aspect of the present invention is to provide a fluidic nano/micro array chip, which is not only able to print hundreds to thousands of samples simultaneously, but also able to print several times repeatedly, so as to print tens of thousands of dots on the receiving biochip in several minutes.

Another aspect of the present invention is to provide a fluidic nano/micro array chipset, which comprise a microarray filling chip and a nano/micro array stamping chip. The nano/micro array stamping chip can print various kinds of fluids simultaneously and in parallel on the receiving biochip. The biochip on which the fluid nano/micro array chip prints is of low cost, and is disposable, which avoids the effect of leaving unused samples after the cleaning process of a conventional mechanical micro printing system or an inkjet nozzle method.

A fluidic nano/micro array chip according to one aspect of the present invention comprises at least a liquid containing layer, a plurality of vertical channels arranged in an array pattern, and a plurality of hollow stamping heads. The liquid containing layer includes a liquid injecting container and a plurality of horizontal micro channels connected to the liquid injecting container. Each horizontal micro channel is connected to at least one of the vertical channels. Each of the hollow stamping heads is connected to one vertical channel. Sample solution contained in the liquid injecting container flows through the horizontal micro channels and the vertical channels and is printed by the hollow stamping heads on a biochip.

A fluidic nano/micro array chipset according to another aspect of the present invention comprises a microarray filling chip and a nano/micro array stamping chip. There are a plurality of sample containers and a plurality of nano/micro channels on the top of the microarray filling chip, and a plurality of nano/micro-degreed micro filling holes on the bottom of the microarray filling chip. Each of the nano/micro channels is connected to one of the sample containers and directs the sample solution in this sample container to flow to the corresponding micro filling hole. The nano/micro array stamping chip comprises a plurality of stamping heads arranged in an array pattern, a body part of the stamp chip, and a plurality of separating channels forming a hydrophobic area. Each sample solution is contained in the body part of the stamp chip, and is transported by the corresponding stamping head to a stamping part of this stamping head.

### BRIEF DESCRIPTION OF THE DRAWINGS

The objectives and advantages of the present invention will become apparent upon reading the following description and upon reference to the accompanying drawings in which:

FIG. 1 shows a perspective view of a fluidic nano/micro array chip and a biochip in accordance with the present invention;

FIGS. 2A to 2C are cross-sectional views along line 1-1 in FIG. 1 showing the steps of the sample solution stamping process of a fluidic nano/micro array chip in accordance with the present invention;

FIG. 3 shows a perspective view of a microarray filling chip of a fluidic nano/micro array chipset in accordance with the present invention;

FIG. 4 shows a cross-sectional view of a microarray filling chip in accordance with the present invention;

FIG. 5 shows a cross-sectional view of a nano/micro array stamping chip of the fluidic nano/micro array chipset in accordance with the present invention;

FIGS. 6A to 6I are schematic views showing the steps of the sample solution stamping process of a fluidic nano/micro array chipset in accordance with the present invention;

FIG. 7A shows a perspective view of another nano/micro array stamping chip of the fluidic nano/micro array chipset in accordance with the present invention;

FIG. 7B is a cross-sectional view of the nano/micro array stamping chip 70 along line 2-2 in FIG. 7A;

FIGS. 8A to 8F are schematic views showing the steps of the sample solution stamping process of a fluidic nano/micro array chipset in accordance with the present invention;

FIG. 9 shows a cross-sectional view of another nano/micro array stamping chip of a fluidic nano/micro array chipset in accordance with the present invention;

FIGS. 10A to 10F are schematic views showing the steps of the sample solution stamping process of a fluidic nano/micro array chipset in accordance with the present invention;

FIG. 11 is a cross-sectional view showing another nano/micro array stamping chip of a fluidic nano/micro array chipset in accordance with the present invention;

FIGS. 12A to 12F are schematic views showing the steps of the sample solution stamping process of a fluidic nano/micro array chipset in accordance with the present invention; and

FIG. 13 shows a result of the sample solution stamping process of a fluidic nano/micro array chipset in accordance with the present invention.

### DETAILED DESCRIPTION OF THE INVENTION

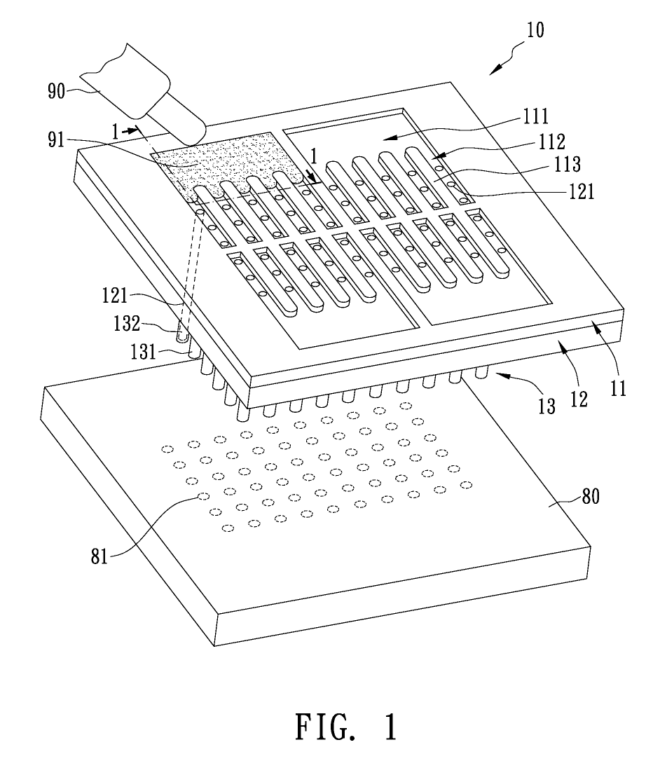

FIG. 1 shows a perspective view of a fluidic nano/micro array chip and a biochip in accordance with the present invention. A fluidic nano/micro array chip 10 comprises a liquid containing layer 11, a vertical transporting layer 12, and a stamping head layer 13, wherein the vertical transporting layer 12 is interposed between the liquid containing layer 11 and the stamping head layer 13. The liquid containing layer 11 includes a plurality of liquid injecting containers 111 and a plurality of horizontal micro channels 112 connected to the liquid injecting containers 111. Each of the horizontal micro channels 112 is separated from one another by at least one separating part 113, and is connected to at least one vertical channel 121 in a vertical transporting layer 12. The liquid containing layer 11 and the vertical transporting layer 12 are made of high polymer or semiconductor materials, such as thick film photoresist SU8. The stamping head layer 13 is made of elastic high polymer materials, such as silicone.

When a pipette 90 fills a sample solution 91 into the liquid injecting container 111 of the liquid containing layer 11, the sample solution 91 will flow to and cover all of the horizontal micro channels 112 by means of surface tension. While each of the horizontal micro channels 112 is connected to the vertical channels 121 in the vertical transporting layer 12, the sample solution 91 will flow through vertical channels 121 by means of capillary force and will flow into a plurality of hollow inner pipes 132 of a plurality of stamping heads 131 mounted on the stamping head layer 13. After the stamping heads 131 are filled with the sample solution 91, the fluidic nano/micro array chip 10 moves downward to contact a receiving biochip 80 in order to print the sample solution 91 as a plurality of nano/micro liquid droplets 81 on the surface of the biochip 80.

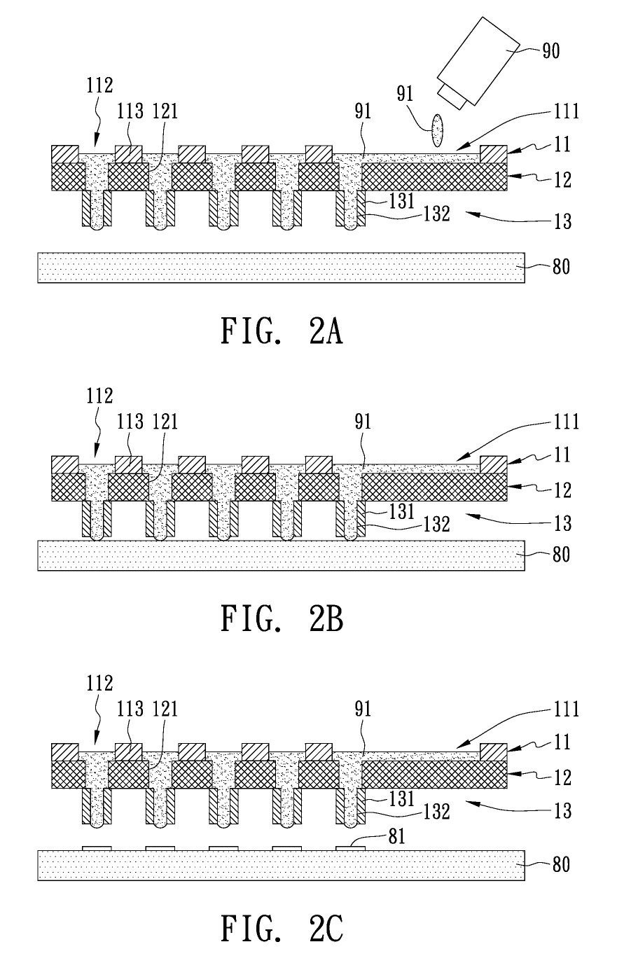

FIGS. 2A to 2C are cross-sectional views along line 1-1 in FIG. 1 showing the steps of the sample solution stamping process of a fluidic nano/micro array chip in accordance with the present invention. The sample solution 91 first fills the liquid injecting container 111 of the liquid containing layer 11, and then flows into the connected horizontal micro channels 112. Several different liquid injecting containers 111 can be designed to connect to the corresponding horizontal micro channels 112, that is, different sample solutions 91 will flow into their corresponding horizontal micro channels 112. The sample solutions 91 will flow through the vertical channels 121 by means of capillary force and reach the hollow inner pipes 132 of stamping heads 131, wherein the stamping heads 13 are mounted on the vertical transporting layer 12. As shown in FIG. 2B, after the fluidic nano/micro array chip 10 contacts the biochip 80 for some time, the fluidic nano/micro array chip 10 is separated from the biochip 80, and the nano/micro liquid droplets 81 are formed on the surface of the biochip 80. The finished biochip 80 can then be used in biochemical inspection experiments or other nano/micro semiconductor manufacturing applications.

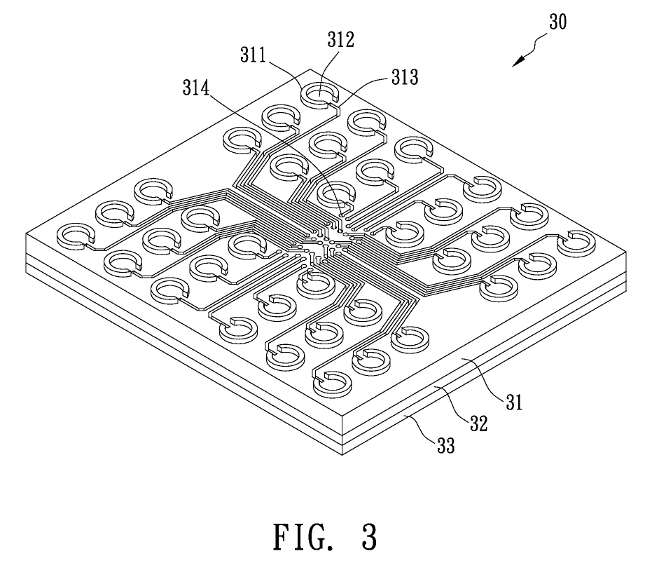

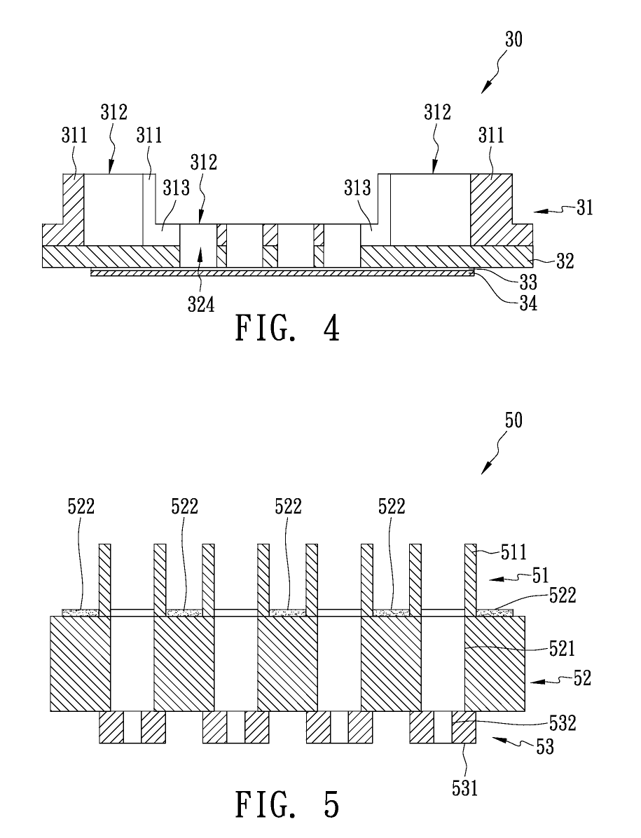

FIG. 3 shows a perspective view of a microarray filling chip of a fluidic nano/micro array chipset in accordance with the present invention. A microarray filling chip 30 is sequentially formed with a liquid directing layer 31, a vertical transporting layer 32, a thin film 33 made of high polymer materials, and a hydrophobic material film 34 (as shown in FIG. 4) from top to bottom. The liquid directing layer 31 includes a plurality of sample containers 312, a plurality of container sidewalls 311, and a plurality of nano/micro channels 313. Each of the nano/micro channels 313 is connected to a sample container 312, and leads the liquid to a vertical channel 314. The thin film 33 is attached to the far side of each vertical channel 314, and forms rooms respectively for different sample solutions.

FIG. 4 shows the cross-sectional view of the microarray filling chip of the present invention. Each sample container 312 is a room surrounded by the corresponding sidewall 311, which has a notch connected with the nano/micro channel 313. Each nano/micro channel 313 is connected to the corresponding vertical channel 314, while each vertical channel 314 is connected to a nano/micro-scale filling hole 324. The hydrophobic material film 34 can prevent the sample solutions in each micro filling hole 324 from contaminating each other after the thin film 33 is penetrated, namely, it can prevent the sample solutions from flowing transversally on the lower surface of the microarray filling chip 30.

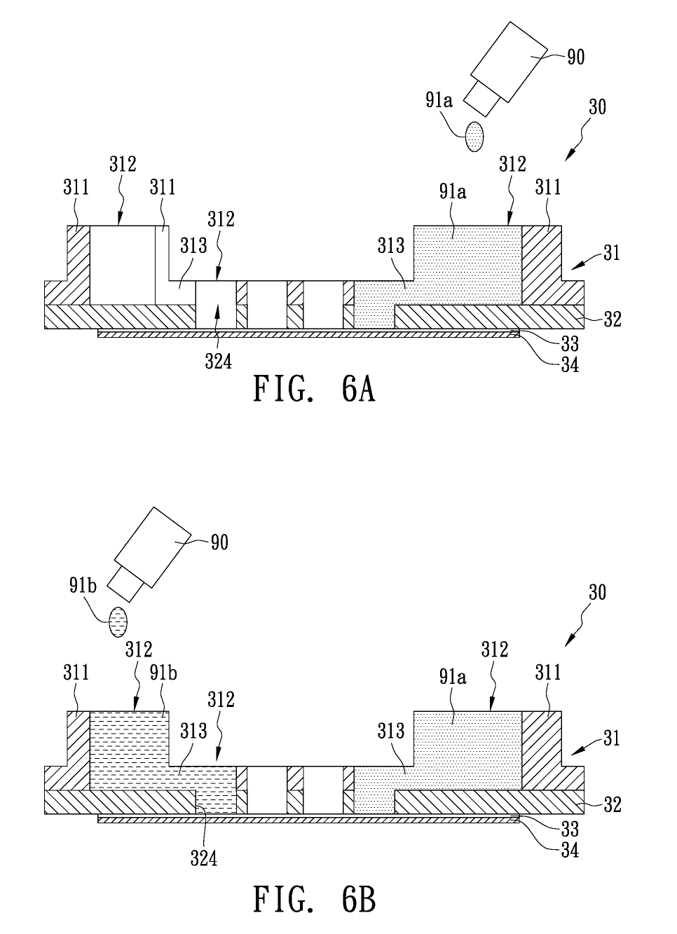

FIG. 5 shows the cross-sectional view of the nano/micro array stamping chip of a fluidic nano/micro array chipset of the present invention. The nano/micro array stamping chip 50 and the microarray filling chip 30 compose the fluidic nano/micro array chipset of the present invention, wherein this chipset can provide multiple times of sample printing repeatedly, or fill different samples in the nano/micro array stamping chip 50 at one time. The nano/micro array stamping chip 50 comprises a liquid directing pipe layer 51, a body layer 52, and a stamping head layer 53. The liquid directing pipe layer 51 contains a plurality of semi-cylinder pipes 511 made of thick film photoresist materials. In the body layer 52, a vertical channel 521 is placed under each of two pipes 511. Also, there can be only one pipe 511 beside one side of the vertical channel 521, which can also act as the nano/micro channel 313 in FIG. 4. To prevent the sample solutions from contaminating each other, a hydrophobic material, such as Teflon, can be disposed between the vertical channels 521 of the body layer 52, which is made of thick film photoresist materials, to form a hydrophobic area 522. After filling, each sample solution flows vertically downward into a hollow inner pipe 532 of the corresponding stamping head 531 of the stamping head layer 53. The stamping heads 531 are made of elastic high polymer materials, such as PDMS, and therefore several different kinds of sample solutions can be printed in parallel on the receiving biochip at one time.

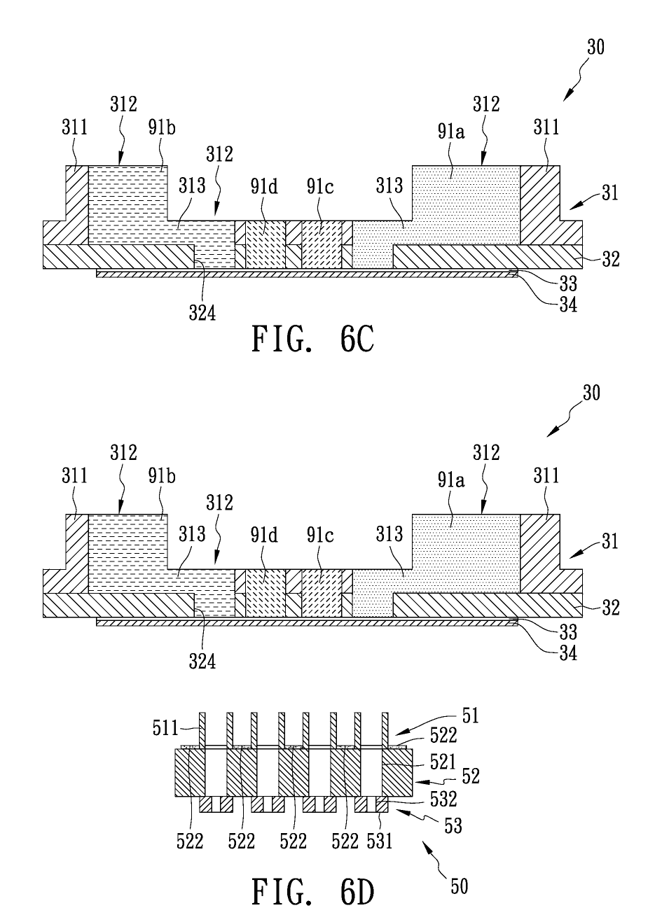

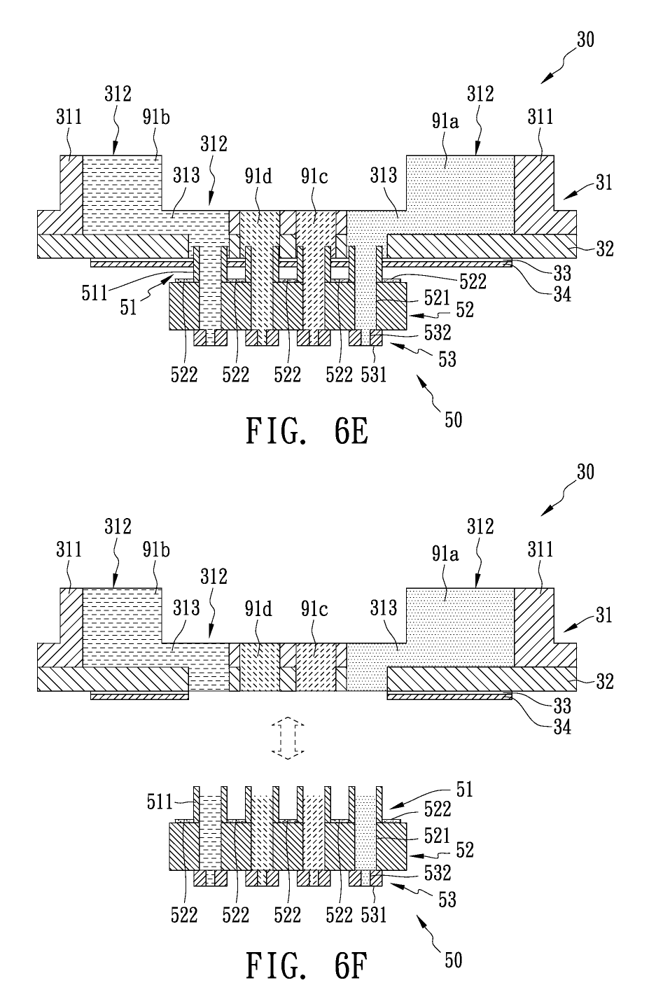

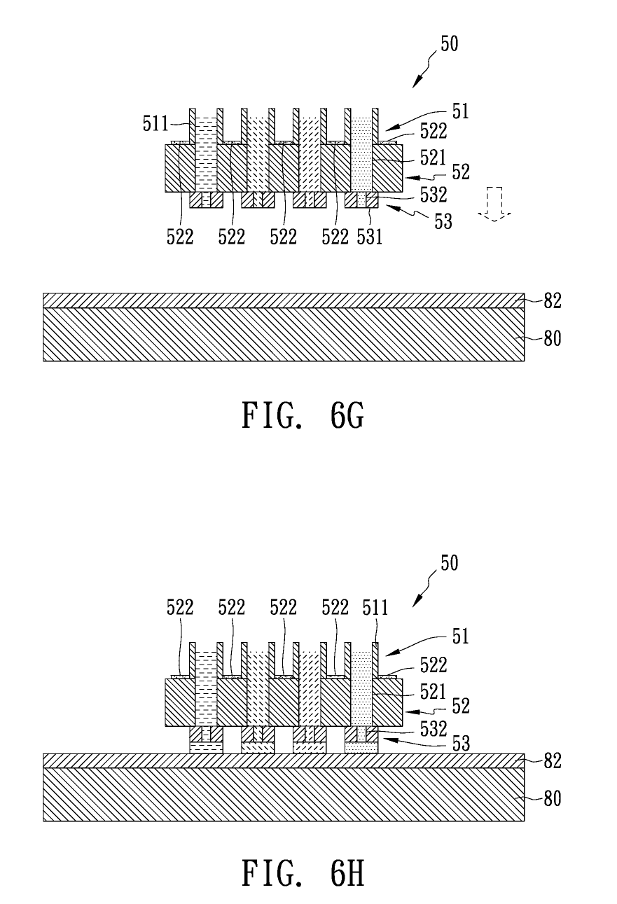

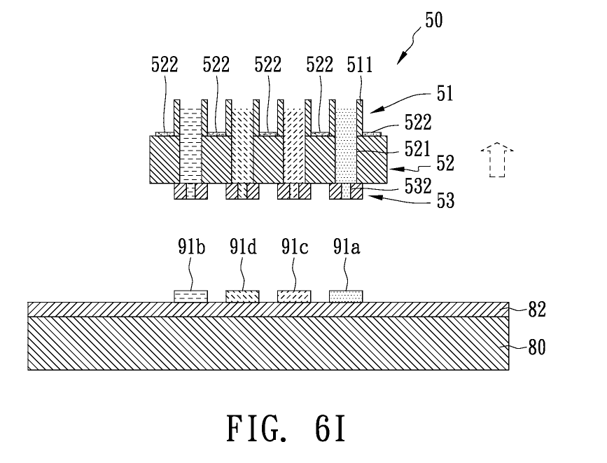

FIGS. 6A to 6I are schematic views showing steps of the sample solution stamping process by employing the fluidic nano/micro array chipset of the present invention. The pipette 90 fills a sample solution 91a into the sample container 312 on the right side, and the sample solution 91a flows through the nano/micro channel 313 and the vertical channel 314 into the space formed between the micro filling hole 324 and the thin film 33. As shown in FIGS. 6B to 6C, the pipette 90 can also fill another sample solution 91b into the sample container 312 on the left side, and likewise, the sample container 312 in the center connected to two micro filling holes 324 can also filled with the different sample solutions 91c and 91d.

As shown in FIGS. 6D to 6F, the nano/micro array stamping chips 50 are disposed under the microarray filling chip 30, and the columns 511 of the liquid directing column layer 51 face the micro filling holes 324 and penetrate the thin film 33. Each column 511 is inserted into the corresponding micro filling hole 324 simultaneously, and the sample solutions 91a to 91d are directed via the nano/micro channels 313 to the corresponding vertical channels 521 and the hollow inner pipes 532 of the stamping heads 531. Until each hollow inner pipe 532 of the stamping heads 531 is full of the corresponding sample solutions 91a to 91d, the nano/micro array stamping chip 50 is withdrawn from the microarray filling chip 30, while the remaining sample solutions 91a to 91d in the microarray filling chip 30 can provide for many repeated iterations of the filling process. The stamping heads 531 filled with the sample solutions 91a to 91d are then moved above a biochip 80, and the biochip 80 has a SAMs layer 82 disposed on its surface, as shown in FIG. 6G. When the stamping heads 531 press upon the surface of the SAMs layer 82, the sample solutions 91a to 91d will be dropped on the surface of the SAMs layer 82, and be arranged in a liquid droplet array pattern on the surface of the biochip 80, as shown in FIGS. 6H to 6I.

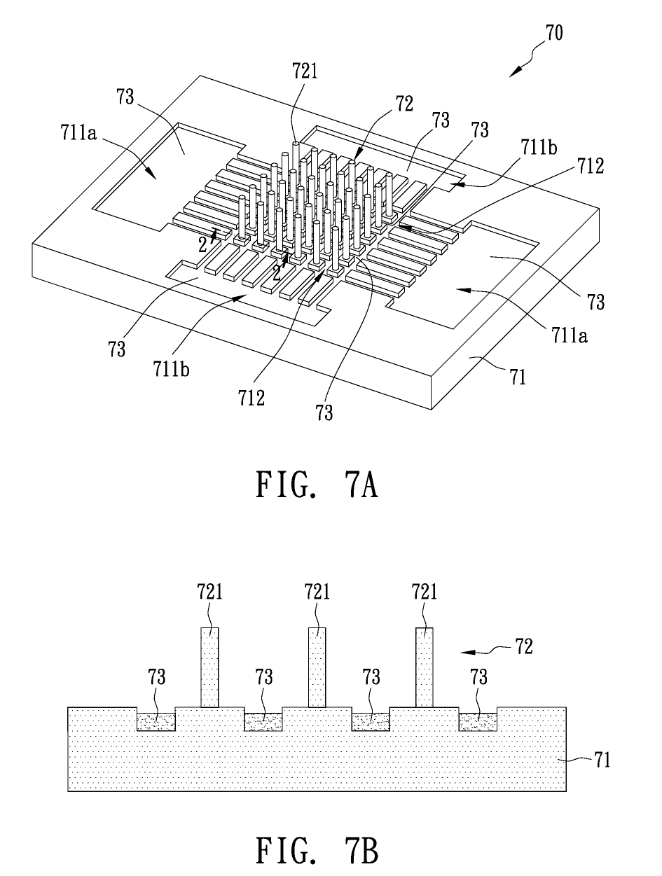

FIG. 7A shows a perspective view of another nano/micro array stamping chip of the fluidic nano/micro array chipset in accordance with the present invention. A nano/micro array stamping chip 70 can replace the aforesaid nano/micro array stamping chip 50, and is together with the microarray filling chip 30 to have another fluidic nano/micro array chipset. The nano/micro array stamping chip 70 comprises a body of the stamping chip 71 and a stamping head layer 72. Hydrophobic material loading containers 711a and 711b are disposed on the four sides of the body 71. A plurality of space channels 712 connected to the hydrophobic material loading containers 711a and 711b intersect each other. The hydrophobic material loading containers 711a and 711b can be filled with a liquid hydrophobic material 73, such as Teflon, and the space channels 712 can also be filled with the liquid hydrophobic material 73. When the hydrophobic material 73 has solidified, a plurality of stamping heads 721 of the stamping head layer 72 will also be separated by the hydrophobic material.

FIG. 7B is a cross-sectional view of the nano/micro array stamping chip 70 along line 2-2 in FIG. 7A. The stamping heads 721, which are made of elastic materials, such as PDMS, are erected on the top of the body part 71, which is made of the same elastic materials, while the space channels 712 between the stamping heads 721 are covered with the hydrophobic material 73.

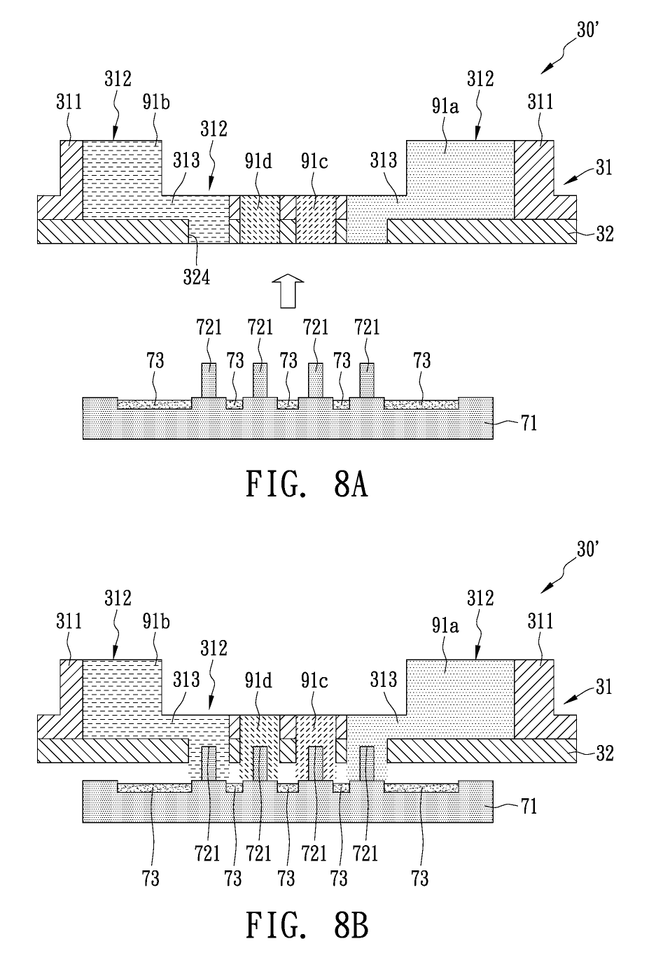

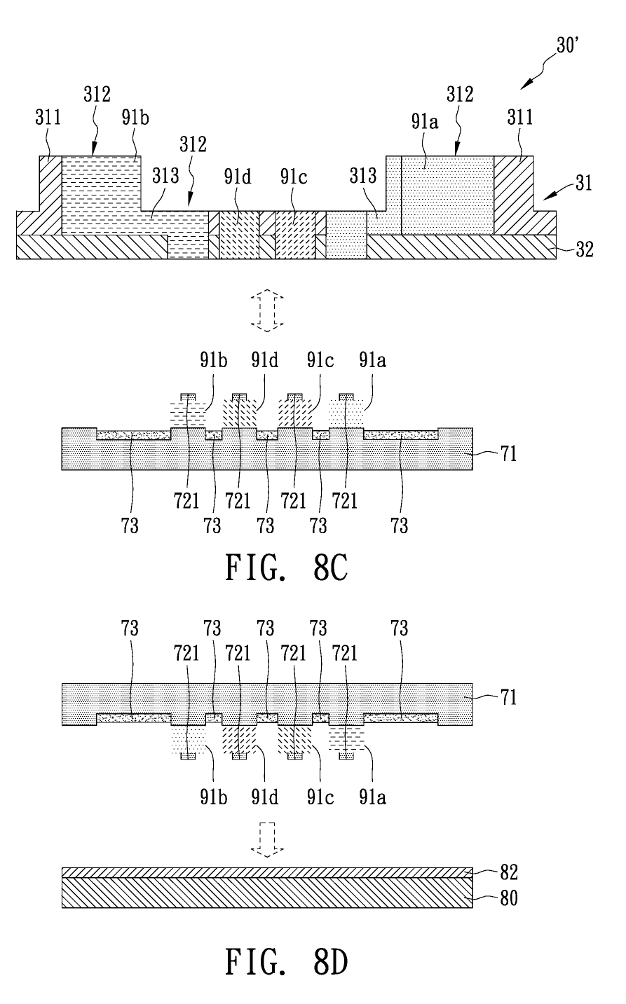

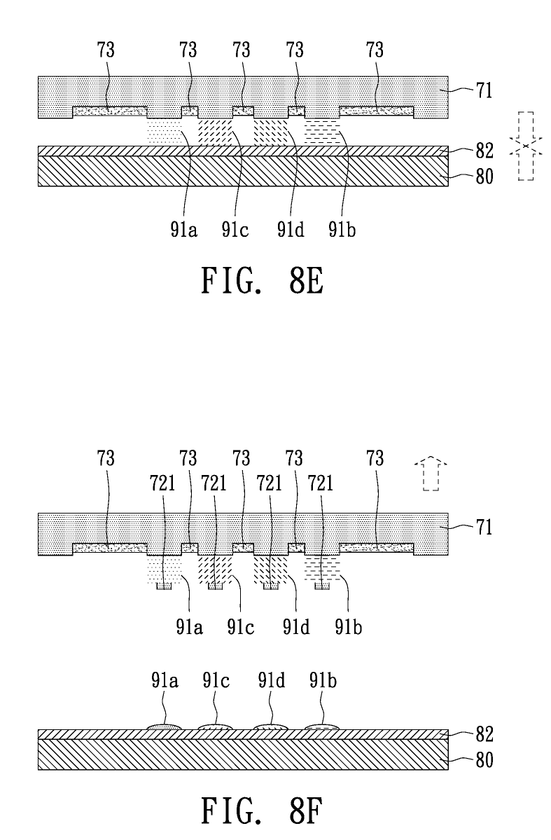

FIGS. 8A to 8F are schematic views showing the steps of the sample solution stamping process of a fluidic nano/micro array chipset in accordance with the present invention. The nano/micro array stamping chip 70 is placed under the microarray filling chip 30′ (without the thin film 33), and the stamping heads 721 on the stamping head layer 72 face the micro filling holes 324. Each stamping head 721 is inserted into the corresponding micro filling hole 324 simultaneously, and one of the sample solutions 91a-91d is led from the nano/micro channels 313 to the sides of a stamping head 721. Because the space channels 712 between the stamping heads 721 are covered with the hydrophobic material 73, the sample solutions 91a-91d cannot flow thereon. After each of the sample solutions 91a-91d surrounds one of the stamping heads 721, the nano/micro array stamping chip 70 is withdrawn from the microarray filling chip 30′, and the remaining sample solutions 91a-91d in the microarray filling chip 30′ can provide for multiple times of filling process.

The stamping heads 721 respectively filled with the sample solutions 91a-91d are then moved on the top of the biochip 80, and a SAMs layer 82 is disposed on the biochip 80, as shown in FIG. 8D. When the stamping heads 531 press upon the surface of the SAMs layer 82, the sample solutions 91a-91d will be dropped along the stamping heads 721 on the surface of the SAMs layer 82, and be arranged in a liquid droplet array pattern on the surface of the biochip 80, as shown in FIGS. 8E to 8F.

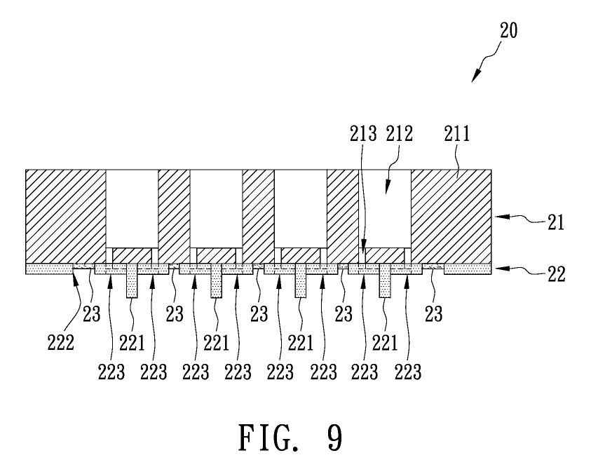

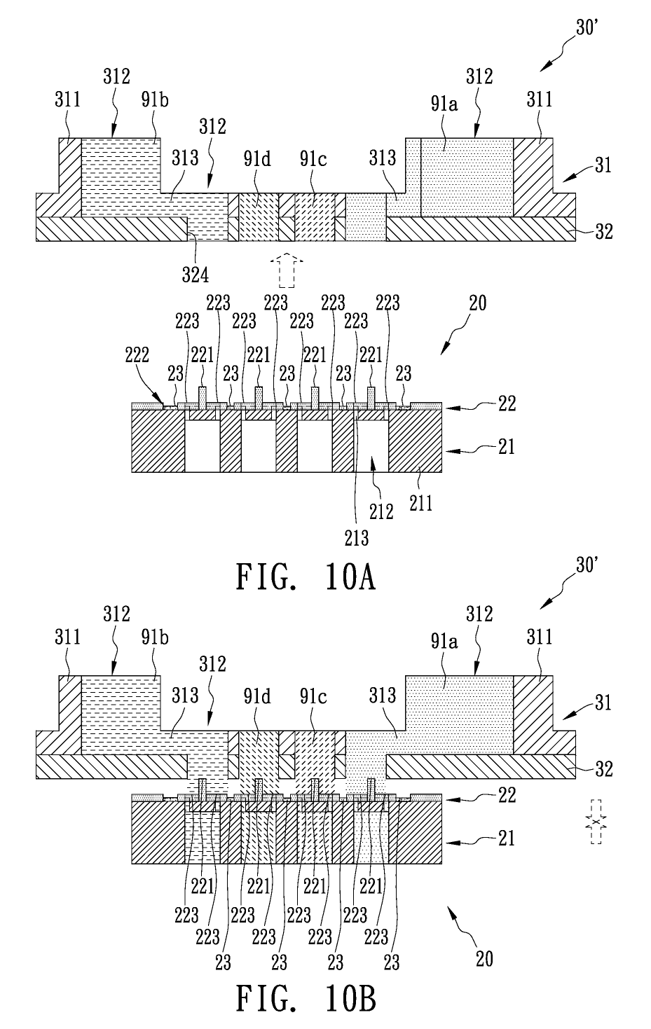

FIG. 9 shows a cross-sectional view of another nano/micro array stamping chip of the fluidic nano/micro array chipset in accordance with the present invention. A nano/micro array stamping chip 20 can replace the aforesaid nano/micro array stamping chip 70, and is arranged together with the microarray filling chip 30′ to compose a different fluidic nano/micro array chipset. The nano/micro array stamping chip 20 comprises a body part of the stamping chip 21 and a stamping head layer 22. Likewise, a plurality of stamping heads 221 are isolated by a plurality of space channels 222, while the space channels 222 are covered with a hydrophobic material 23. To improve the storage capacity of the sample solutions 91a to 91d in the nano/micro array stamping chip 70, a substrate 211 of body part 21 can be equipped with a plurality of sample containers 212. The sample solutions flow through a plurality of vertical micro channels 213 and a plurality of lateral micro channels 223 to the corresponding stamping heads 221.

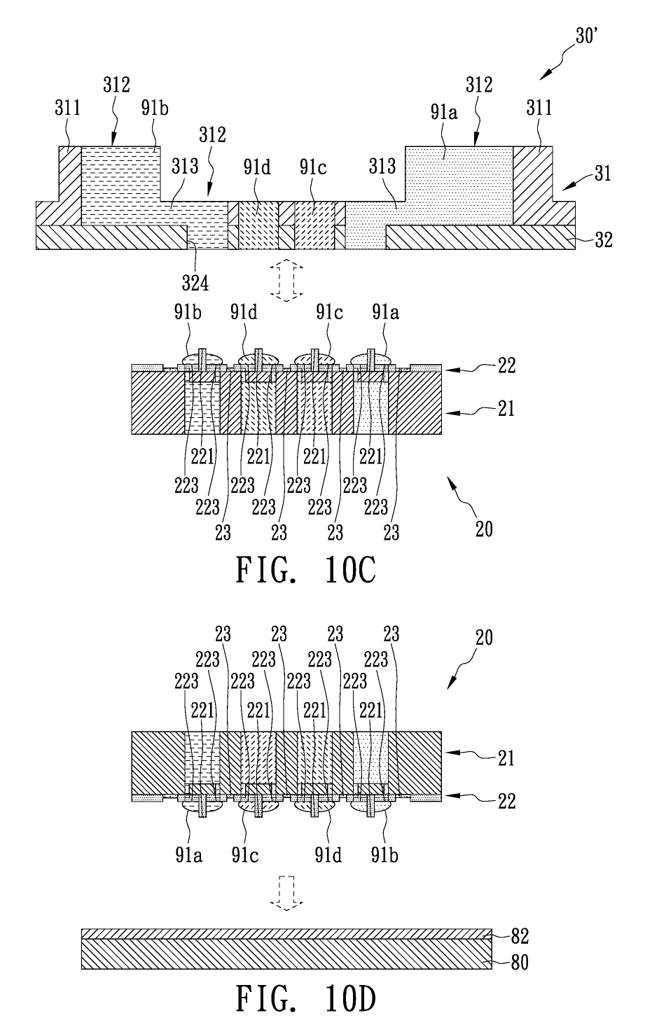

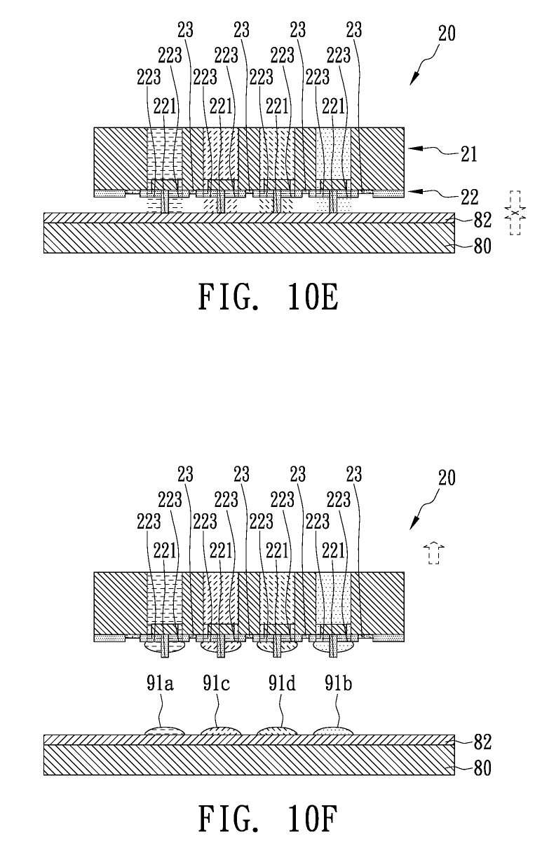

FIGS. 10A to 10F show schematic views of the steps of the sample solution stamping process of the fluidic nano/micro array chipset in accordance with the present invention. The nano/micro array stamping chip 20 is placed under the microarray filling chip 30′, and the stamping heads 221 on the stamping head layer 22 face the micro filling holes 324. Each of the stamping heads 221 is inserted into a corresponding micro filling hole 324 simultaneously, and the micro filling holes 324 lead the sample solutions 91a-91d from the nano/micro channels 313 to the sides of the stamping heads 221. Because the space channels 222 between the stamping heads 221 are covered with the hydrophobic material 23, the sample solutions 91a-91d will not flow sideward, but flow along the vertical micro channels 213 and the lateral micro channels 223 into the corresponding sample containers 212. After the sample containers 212 are full of the sample solutions 91a-91d, the nano/micro array stamping chip 20 is withdrawn from the microarray filling chip 30′.

The stamping heads 221 filled with the sample solutions 91 a to 91 d are then moved to the top of the biochip 80, and the biochip 80 has the SAMs layer 82 disposed upon its surface, as shown in FIG. 10D. When the stamping heads 221 press upon the surface of the SAMs layer 82, the sample solutions 91a to 91d will be dropped along the stamping heads 221 on the surface of the SAMs layer 82, and be arranged in a liquid droplet array pattern on the surface of the biochip 80, as shown in FIGS. 10E to 10F.

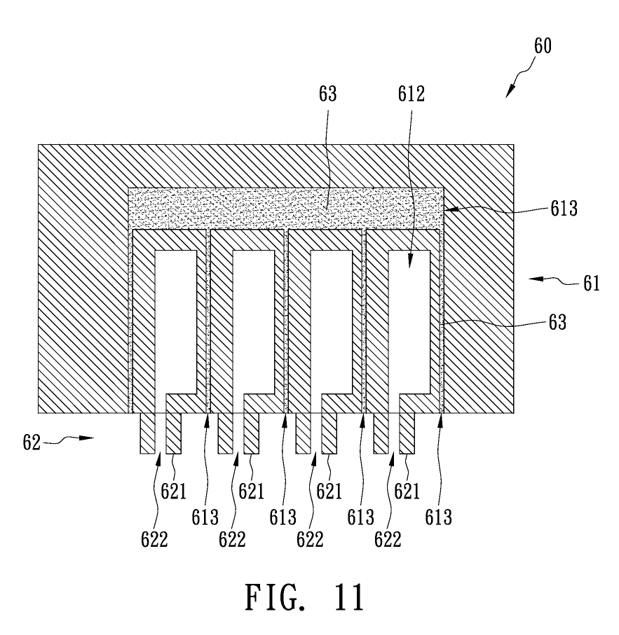

FIG. 11 shows a cross-sectional view of another nano/micro array stamping chip of the fluidic nano/micro array chipset in accordance with the present invention. A nano/micro array stamping chip 60 can replace the nano/micro array stamping chip 20. The nano/micro array stamping chip 60 is a one-dimensional array stamping chip, but several chips can be put together to form a two dimensional array stamping chip. The nano/micro array stamping chip 60 arranged together with the microarray filling chip 30 to compose another fluidic nano/micro array chipset. The nano/micro array stamping chip 60 comprises a body of the stamping chip 61 and a stamping head layer 62. Similarly, a plurality of stamping heads 621 are isolated by a plurality of space channels 613, while the space channels 613 are covered with a hydrophobic material 63. The original liquid hydrophobic material 63 can be injected from a hydrophobic material loading container 614, and flows along the space channels 613. Finally, the hydrophobic material 63 separates a plurality of sample containers 612 from each other. In this regard, contamination can be avoided when the sample containers 612 are full of the sample solutions. The sample solutions will be supplied from the sample containers 612 in the body 61 to the corresponding stamping heads 621, and flow out of a plurality of inner pipes 622.

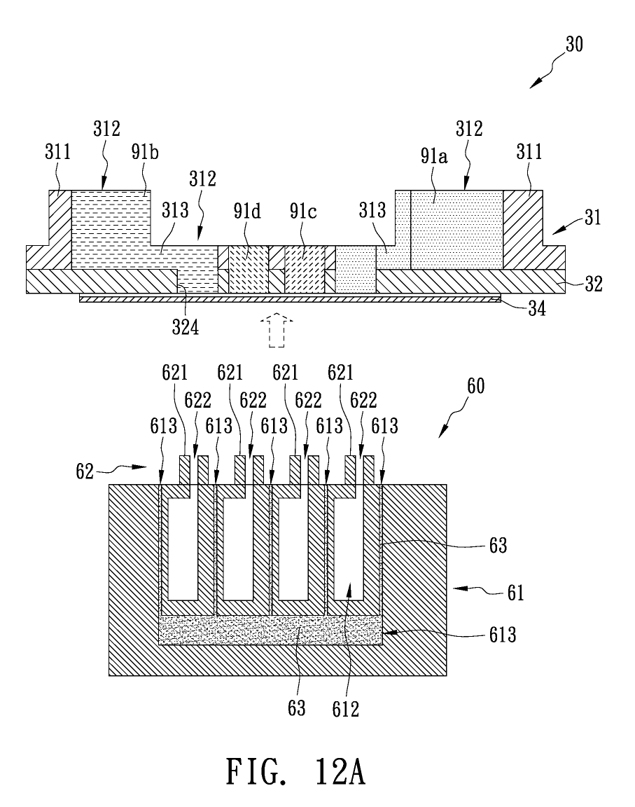

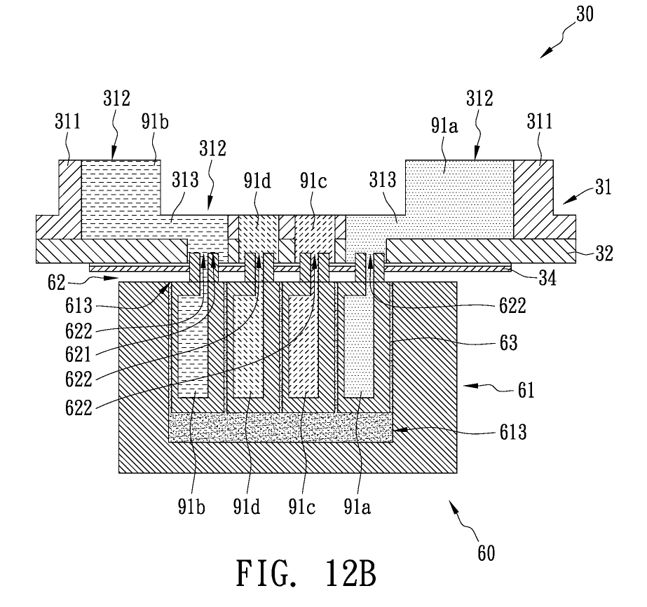

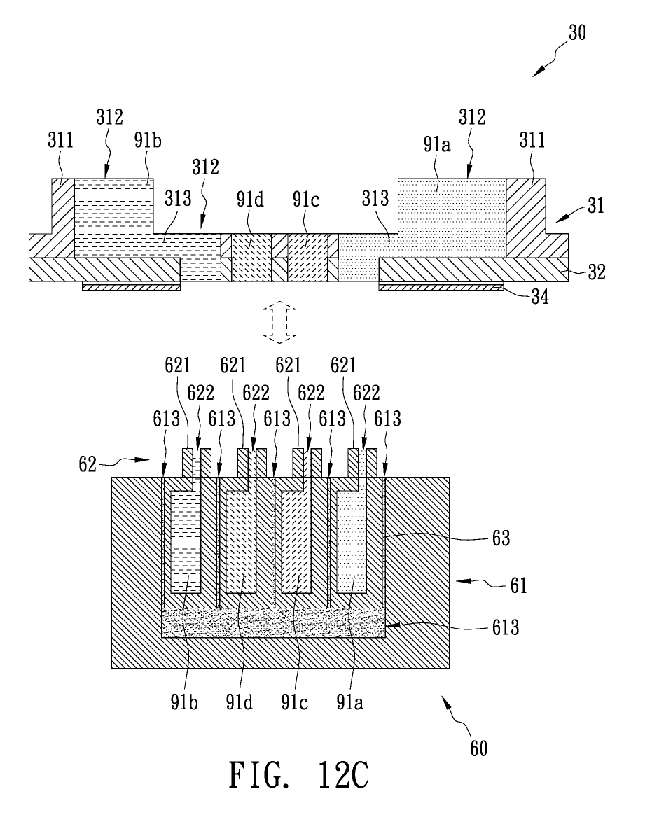

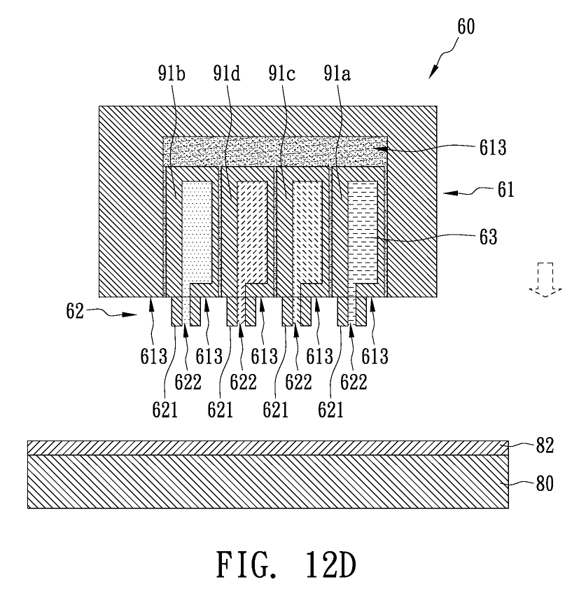

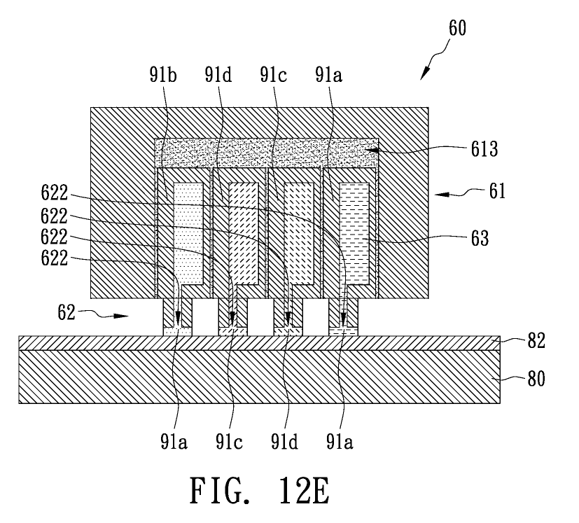

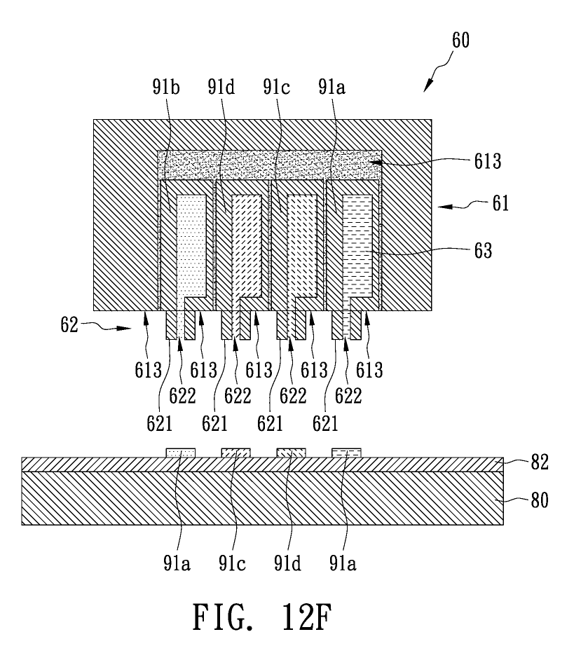

FIGS. 12A to 12F show schematic views of the steps of the sample solution stamping process of the fluidic nano/micro array chipset in accordance with the present invention. The nano/micro array stamping chip 60 is placed under the microarray filling chip 30, and the stamping heads 621 on the stamping head layer 62 face the micro filling holes 324. Each stamping head 621 is inserted into a corresponding micro filling hole 324 simultaneously, and the sample solutions 91a-91d are directed through the nano/micro channel 313 into the inner pipe 622 of the stamping head 221. Because the space channels 613 between the stamping heads 621 are covered with the hydrophobic material 23, the sample solutions 91a-91d will not flow horizontally to cause cross contamination. After the sample containers 612 are full of sample solutions 91a to 91d, the nano/micro array stamping chip 60 is withdrawn from the microarray filling chip 30. In stead of the microarray filling chip 30, the sample solutions 91a-91d can be directly and respectively dropped into the sample containers 612.

The stamping heads 621 filled with sample solutions 91a to 91d are then moved to the top of the biochip 80, and the biochip 80 has the SAMs layer 82 disposed upon its surface, as shown in FIG. 12D. When the stamping heads 621 press upon the surface of the SAMs layer 82, the sample solutions 91a to 91d will be dropped along the stamping heads 621 on the surface of the SAMs layer 82, and be arranged in a liquid droplet array pattern on the surface of the biochip 80, as shown in FIGS. 12E-12F.

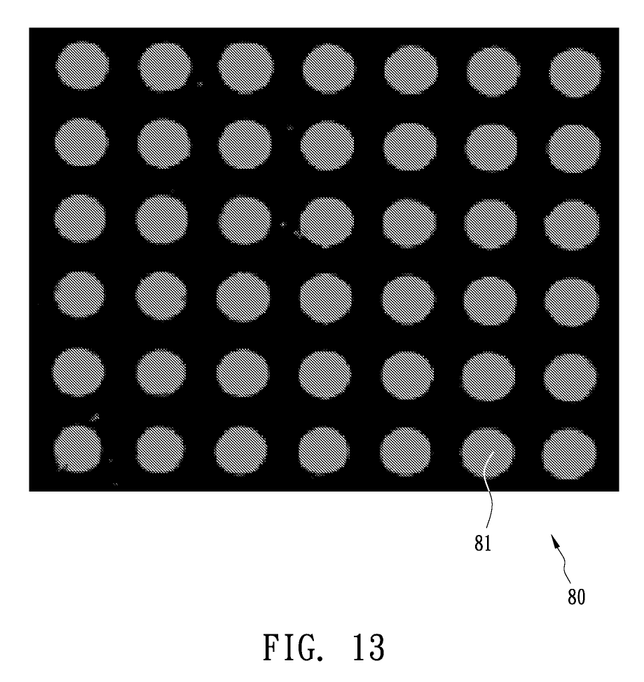

FIG. 13 shows a result of the sample solution stamping process of the fluidic nano/micro array chipset in accordance with the present invention. After printing or stamping, the nano/micro liquid droplets 81 are arranged in array pattern on the biochip 80. Fluorescence scanning shows that all liquid droplets 81 are substantially the same size.

The above-described embodiments of the present invention are intended to be illustrative only. Those skilled in the art may devise numerous alternative embodiments without departing from the scope of the following claims.

What is claimed is:

1. A fluidic nano/micro array chip for stamping a plurality of nano/micro liquid droplets of a plurality of sample solutions on a biochip, comprising:
a liquid containing layer filled with and transporting the sample solutions;
a vertical transporting layer comprising a plurality of vertical channels connected to the liquid containing layer, wherein the vertical channels can transport the sample solutions; and
a stamping head layer comprising a plurality of stamping heads respectively connected to the vertical channels.

2. The fluidic nano/micro array chip of claim 1, wherein the liquid containing layer further comprises a plurality of liquid injecting containers and a plurality of horizontal micro channels connected to the liquid injecting containers, and the horizontal micro channels are vertically connected to at least one of the vertical channels in the vertical transporting layer.

3. The fluidic nano/micro array chip of claim 1, wherein the vertical channels transport the sample solutions by means of capillary force.

4. The fluidic nano/micro array chip of claim 1, wherein the liquid containing layer and the vertical transporting layer are made of a thick film photoresist material.

5. The fluidic nano/micro array chip of claim 1, wherein the stamping head layer is made of an elastic high polymer material.

6. The fluidic nano/micro array chip of claim 1, wherein each of the stamping heads includes a pipe.

7. A fluidic nano/micro array chip for stamping a plurality of nano/micro liquid droplets of a plurality of sample solutions on a biochip, comprising:
a liquid directing column layer comprising a plurality of columns directing the sample solutions;
a body layer comprising a plurality of vertical channels transporting the sample solutions directed by the columns; and
a stamping head layer comprising a plurality of stamping heads respectively connected to the vertical channels.

8. The fluidic nano/micro array chip of claim 7, further comprising a plurality of hydrophobic areas disposed between the columns, wherein the hydrophobic areas are covered with a hydrophobic material preventing the sample solutions from flowing between the columns.

9. The fluidic nano/micro array chip of claim 7, wherein the liquid directing column layer and the body layer are made of a thick film photoresist material.

10. The fluidic nano/micro array chip of claim 7, wherein the stamping head layer is made of an elastic high polymer material.

11. The fluidic nano/micro array chip of claim 7, wherein the stamping head layer is made of PDMS.

12. A fluidic nano/micro array chip, which prints a plurality of nano/micro liquid droplets of a plurality of sample solutions on a biochip, comprising:
a body of the stamping chip; and
a stamping head layer comprising a plurality of stamping heads erected on the body of the stamping chip, wherein the stamping heads direct the sample solutions and print the nano/micro liquid droplets.

13. The fluidic nano/micro array chip of claim 12, further comprising at least a hydrophobic material loading groove disposed on edges of the body of the stamping chip.

14. The fluidic nano/micro array chip of claim 13, wherein the body of the stamping chip comprises a plurality of space channels connected to the hydrophobic material loading layer and isolating the stamping heads from each other.

15. The fluidic nano/micro array chip of claim 14, wherein the hydrophobic material loading layer and the space channels are covered with a hydrophobic material.

16. The fluidic nano/micro array chip of claim 12, wherein the body of the stamping chip further comprises a plurality of sample containers placed under bases of the stamping heads.

17. The fluidic nano/micro array chip of claim 16, wherein the body of the stamping chip further comprises a plurality of micro channels connected to the sample containers, and each of the micro channels transports one of the sample solutions to one of the stamping heads or one of the sample containers.

18. The fluidic nano/micro array chip of claim 17, wherein each of the micro channels includes a vertical channel connected to one of the sample containers and a lateral channel connected to the vertical channel, and an end of the lateral channel is proximate to a base of the stamping head.

19. The fluidic nano/micro array chip of claim 16, wherein each of the stamping head has a pipe that can transport one of the sample solutions to the sample container connected to the pipe or transport the sample solution to the stamping head.

20. The fluidic nano/micro array chip of claim 19, further comprising a plurality of hydrophobic areas placed between the sample containers, wherein the hydrophobic areas are covered with a hydrophobic material preventing the sample solutions from flowing between sample containers.

21. A fluidic nano/micro array chipset for stamping a plurality of nano/micro liquid droplets of a plurality of sample solutions on a biochip, comprising:
a micro array filling chip comprising a plurality of sample containers and a plurality of micro filling holes connected to the sample containers; and
a nano/micro array stamping chip comprising:
a body; and
a stamping head layer comprising a plurality of stamping heads erected on the body of the stamping chip.

22. The fluidic nano/micro array chipset of claim 21, wherein each of the sample containers includes a sidewall.

23. The fluidic nano/micro array chipset of claim 22, further comprising a plurality of nano/micro channels through the sidewalls, wherein each of the nano/micro channels is connected to one of the sample containers and one of the micro filling holes.

24. The fluidic nano/micro array chipset of claim 21, further comprising a thin film attached to openings of the micro filling holes.

25. The fluidic nano/micro array chipset of claim 24, further comprising a plurality of sample containers and a vertical transporting layer between the micro filling holes, wherein the vertical transporting layer comprises a plurality of vertical channels, and each of the vertical channels is connected to one of the sample containers and one of the micro filling holes.
